(19) United States
(12) Patent Application Publication
(10) Pub. No.: US 2010/0146414 A1
(43) Pub. Date: Jun. 10, 2010

(54) METHOD AND SYSTEM FOR DYNAMIC INSURANCE QUOTES

(75) Inventors: Srinu Kalyan Dongole, Lake Forest, CA (US); Michael D. Mayo, Silverado, CA (US)

Correspondence Address: MCDERMOTT WILL & EMERY LLP, 2049 CENTURY PARK EAST, 38th Floor, LOS ANGELES, CA, 90067-3208, US

(73) Assignee: SUPERIOR ACCESS INSURANCE SERVICES, INC., Irvine, CA (US)

(21) Appl. No.: 12/634,600

(22) Filed: Dec. 9, 2009

Related U.S. Application Data
(63) Continuation of application No. 11/280,543, filed on Nov. 15, 2005, now abandoned.

(51) Int. Cl. G06F 3/048

(52) U.S. Cl. 715/760

(57) ABSTRACT

A system is described which receives data input from a user and then provides that data to multiple web sites interactively in a programmatic manner. In response, each of the web sites return a response to the system. The system collects the responses and displays them for the user. In particular, the web sites may be associated with different insurance carriers and the responses may be insurance premium quotes.

### CROSS-REFERENCE TO RELATED APPLICATION

This application is a continuation application of U.S. patent application Ser. No. 11/280,543, entitled “Method and System for Dynamic Insurance Quotes,” filed. The entire content of this application is incorporated herein by reference.

### BACKGROUND

1. Field

The present disclosure relates generally to interactively providing information from a number of different web sites, and more particularly, to providing insurance quotes from a variety of different carriers.

2. Background

The rapid growth of the Internet itself as well as commerce over the Internet has greatly increased the availability of information to consumers and the competitiveness of the marketplace in many industries. One particular industry in which this is true is that of insurance providers. However, simply having large amounts of information available is not the same as having it easily accessible and useable. Accordingly, various attempts have been made in the past by insurance carriers to provide premium quotes or information on-line for consumer's use.

Some of these attempts have included each insurance carrier providing their own web site which a consumer, or insurance agent, can visit. The consumer visits on their own behalf to receive an insurance quote; while the insurance agent acts as an intermediary on the consumer's behalf. During the visit, the consumer, or agent, is asked a series of questions that are pertinent to an particular insurance product. As is known in this industry, underwriting standards are generated for an insurance product that reflect criteria that establish whether insurance will be offered to a particular consumer and what its cost will be. The questions asked by the web site elicit information about the consumer that is pertinent to the applicable underwriting standard and, based on this information, the insurance carrier, through the web site, provides an insurance quote directed to that particular consumer.

One drawback of such a system is that the consumer, or insurance agent, necessarily must visit numerous web sites to receive numerous insurance quotes for comparison shopping. Furthermore, the data entered at each web site is typically the same or, at the least, very similar. Thus, this process of receiving multiple insurance quotes is repetitive and time consuming from the consumer's, or insurance agent's, point of view.

Another approach is for an intermediary site to collect the information from a number of insurance carriers that is necessary to generate a premium quote for each of the carriers. When a consumer, or agent, visits this site, the consumer's data is entered once and then the intermediary site uses the collected information to generate multiple quotes. Although this approach eliminates much of the repetitiveness described earlier, it also has its own drawbacks. In particular, this approach relies on the insurance carriers cooperating so as to provide the intermediary site with sufficient information relating to generating an accurate quote. Furthermore, the provided information may quickly become out-of-date; thus, requiring frequent and time-consuming updates from multiple insurance carriers.

Accordingly, many opportunities remain for improving the ease and timeliness of providing multiple insurance quotes to a consumer or insurance agent.

### SUMMARY

Accordingly, one aspect described herein relates to a system which receives data input from a user and then provides that data to multiple web sites interactively in a programmatic manner. In response, each of the web sites return a response to the system. The system collects the responses and displays them for the user. In particular, the web sites may be associated with different insurance carriers and the responses may be insurance premium quotes.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of a data collection and dissemination system operating in accordance with the principles of the present invention are illustrated by way of example, and not by way of limitation, in the accompanying drawings, wherein:

FIG. 1 illustrates a block diagram of a computer and network platform on which embodiments of the present invention may be implemented;

FIG. 2 illustrates a block diagram of an exemplary system for providing insurance quotes from multiple carrier web sites;

FIG. 3 depicts a flowchart of an exemplary method to produce respective web browser applications to interface with different carrier web sites;

FIG. 4 depicts a flowchart of an exemplary method for a web browser application to interface with a carrier web site to receive a premium quote;

FIG. 5 depicts a flowchart of an exemplary method for a maintenance component to discover a carrier web site has been updated;

FIGS. 6A-6C depict a screenshot of an exemplary user interface to collect information from a user for developing a premium quote for an insurance product; and

FIG. 7 depicts a screen shot of an exemplary user interface returning multiple insurance quotes to a user.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In particular, embodiments discussed herein are described within the context of the insurance industry and providing insurance quotes to consumers. However, one of ordinary skill will recognize that information unrelated to insurance quotes may be provided in a similar manner without departing from the scope of present invention. For example, the questions asked of a consumer may relate to what type of real-estate they are desiring to purchase instead of insurance products. Accordingly, the multiple web sites would be those of different realtors and, in practice, the real-estate criteria are then used to provide data to each realtor web site. In response, the replies of matching real-estate offerings from each of the realtors' web sites are collected and provided to the consumer. Other, similar scenarios within different industries and contexts are expressly contemplated by the present invention. Additionally, the exemplary embodiment within the context of the insurance industry further includes only one example of an insurance product—an automobile policy. However, other types of insurance products are contemplated as well. Such products may include, but are not limited to, health insurance, commercial auto insurance, workman's compensation insurance, homeowners insurance, and liability insurance. Thus, the particular example of an automobile insurance quote described below is included merely as one concrete example to illustrate the broader concepts and features of the present invention which relate to other insurance products as well as entirely different industries and contexts.

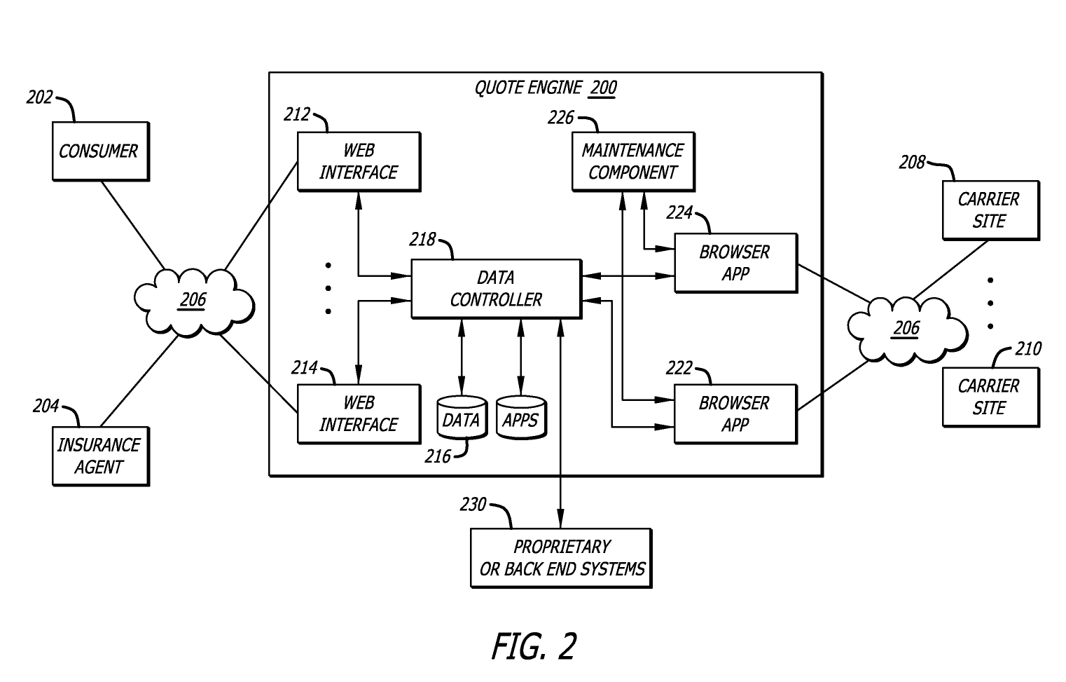

FIG. 2 is a system block diagram of a system that interfaces between multiple users and multiple web sites. In particular, the system 200 may be an insurance quote engine that provides multiple insurance premium quotes to a user. A consumer 202 or an insurance agent 204 interacts with the quote engine 200 via the Internet 206 and a respective web interface 212, 214 provided by the quote engine 200. For example, the quote engine 200 may include a web server that allows a user 202, 204 to login and identify the types of insurance products in which they are interested. The users 202, 204 would use a web browser to interact with a respective web interface 212, 214 to provide the necessary information and receive corresponding replies. Although shown as separate components, the web interfaces 212, 214 are logical in nature and may be implemented through a single web server. The separate logical components merely illustrate the separate interactions with the quote engine 200 by each of the users 202, 204. Furthermore, the Internet 206 is exemplary of any network, wide-area or local-area, that may be used by multiple users to reach the quote engine 200.

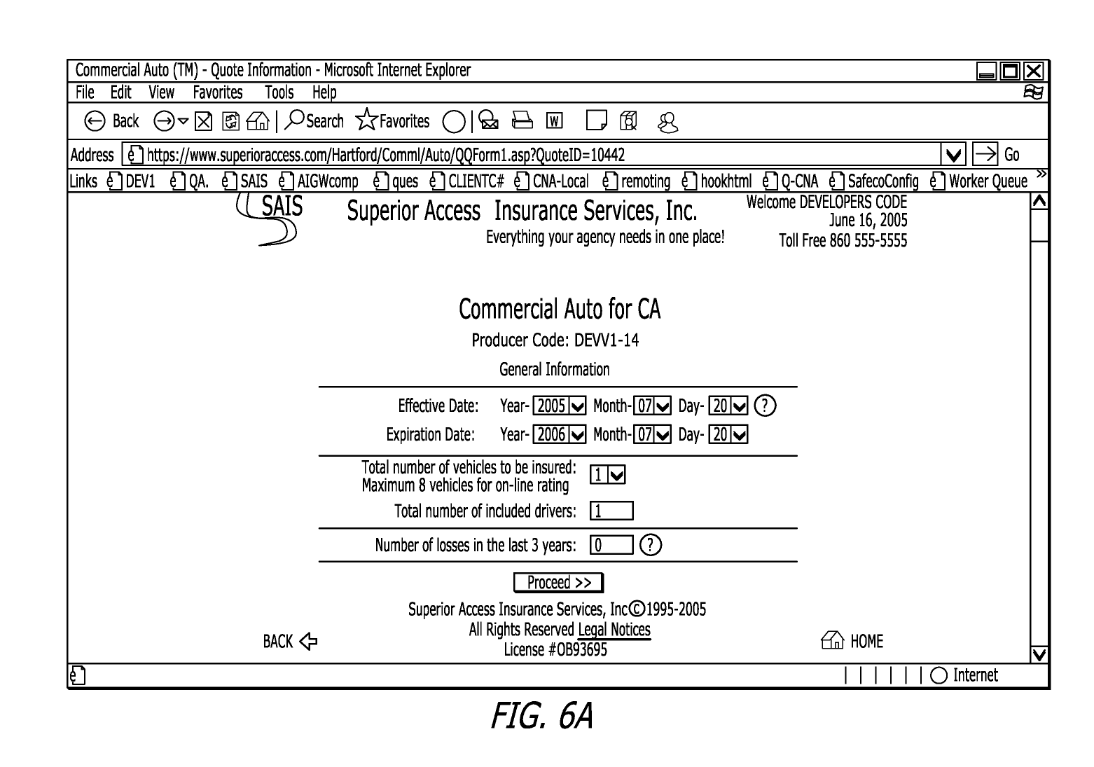

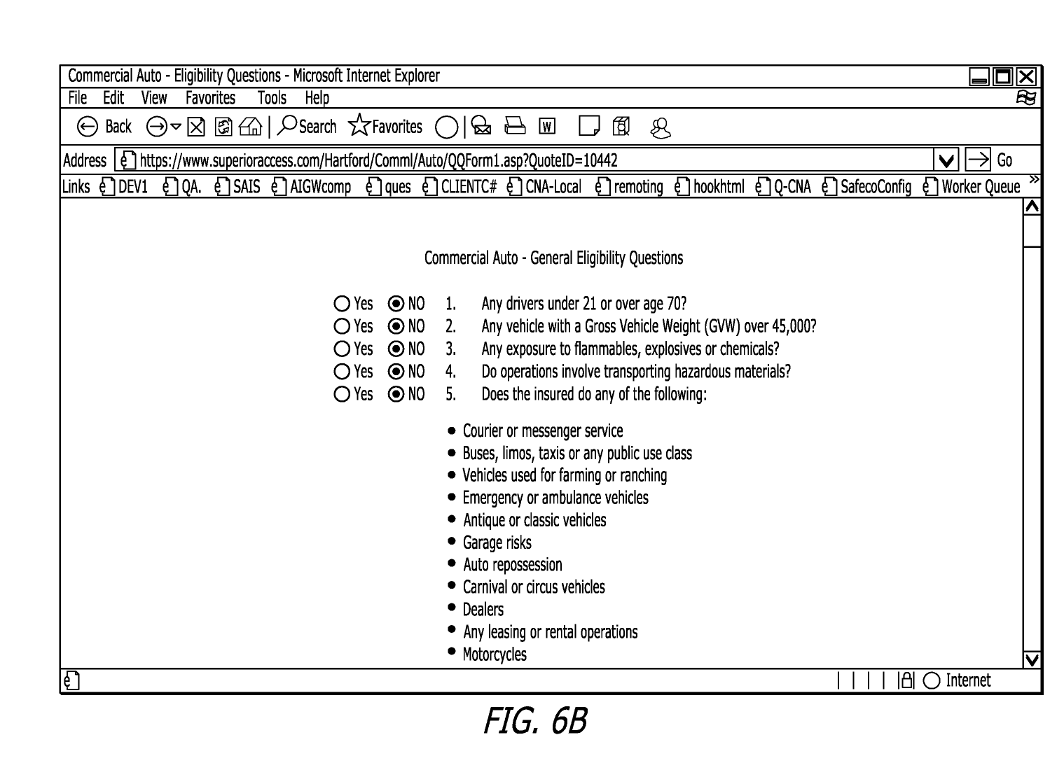

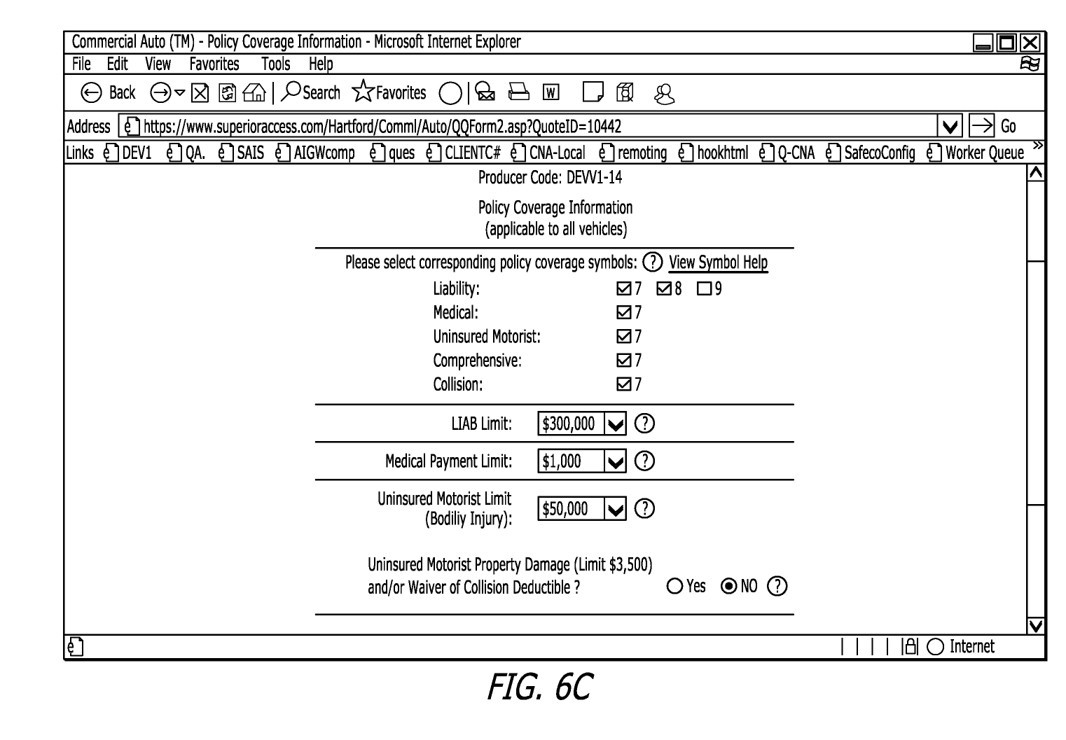

Once a user 202, 204 has arrived at the quote engine 200 and identified, for example, that they would like an automobile insurance quote, a series of questions is provided to the user relevant to generating such a quote. FIGS. 6A-6C are exemplary screenshots of a user's web browser that includes some questions that may be asked relevant to an automobile insurance quote. For other insurance products, different questions would be relevant. The answers to the questions are received and provided to a data controller 218 that stores the data in a database 216. One of ordinary skill will recognize that there are various, functionally equivalent, methods and systems for receiving data, categorizing it, and storing it in a manner which allows easy retrieval of the data. Thus, the data controller 218 and database 216 may be implemented in a number of different ways without departing from the scope of the present invention.

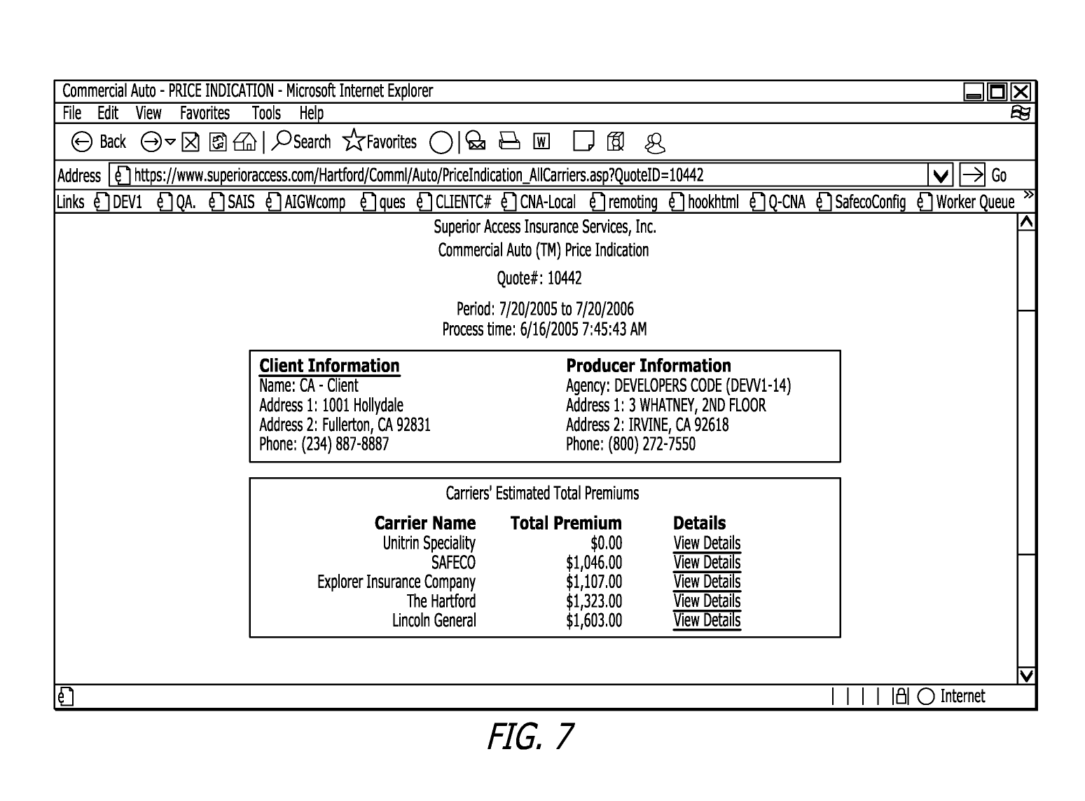

Once relevant data has been received from a user 202, 204, the data controller 218 proceeds to establish communication between the quote engine 200 and a number of different insurance carrier web sites 208, 210. In particular, each of the carrier web sites 208, 210 may be offered by a carrier without knowledge of, or cooperation with, the quote engine 200. Such web sites 208, 210 are generally available over the Internet 206 to any user 202, 204 and allow a user 202, 204 to provide personal information to receive an insurance premium quote. The quote engine 200 utilizes this functionality to interact with multiple such sites 208, 210 and provide relevant data from the database 216. In response, the quote engine receives a premium quote from each site 208, 210 which can be collected and presented to the user 202, 204. Thus, a user 202, 204 simply enters data once through a respective web interface 212, 214 and receives multiple quotes from various carrier web sites 208, 210. The screenshot of FIG. 7 illustrates an exemplary web page that includes links to multiple insurance quotes.

To provide this functionality, the quote engine 200 includes an application that acts like a web browser interacting with the carrier site 208, 210. In particular, the data controller 218 launches a respective web browser application 222, 224 for each insurance carrier site 208, 210. The web browser application 222, 224 has programmed into it knowledge of the web pages and the questions contained therein that will be presented by the carrier web site 208, 210. Thus, based on the insurance carrier and the insurance product, a respective web browser application is programmed to anticipate the series of web pages that the carrier site 208, 210 will present to a user and provide the data needed to answer the questions in those pages.

The different web browser applications 222, 224 are stored in a data store 220 that may or may not be physically separate from the database 216. As explained in more detail below, when the data controller 218 receives input from a user 202, 204 relating to a request for a particular insurance product, the controller 218 retrieves and executes the various web browser applications from the data store 220 that correspond to a respective carrier offering that insurance product. For example, if the request relates to an automobile insurance quote, then every stored web browser application related to that insurance product would be executed and communicate with its respective carrier web site.

It is possible that a carrier may modify the questions or web pages that it presents from its respective web site 208, 210. In such instances, a previously developed web browser application 222, 224 may not be able to complete all the questions asked by the carrier. Therefore, a maintenance component 226 may be used to handle such issues. For example, when the maintenance component 226 determines additional information is needed for a carrier web site that is not programmed into the web browser application 222, 224, the maintenance component 226 may instruct the data controller 218 to retrieve the additional information from a user 202, 204. In this way, the quote engine 200 may continue to operate even though the content of the carrier web sites 208, 210 is dynamic in nature.

In addition to the interface of the quote engine 200 with the carrier web sites 208, 201, other method exist for retrieving quotes from different carriers. For example, a carrier may have a legacy, proprietary or XML interface 230 that they agree to allow the quote engine 200 to connect with. Using the same user information collected earlier, a request using the agreed upon protocol is generated that is sent via the interface 230. In response, the insurance carrier provides a quote to the quote engine 200. This quote may be present to the user 202, 204 as well

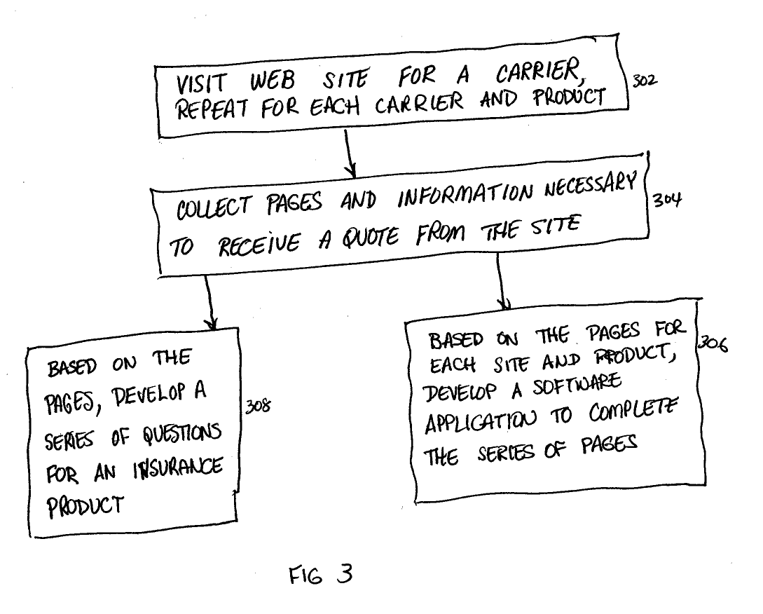

FIGS. 3-5 depict flowcharts of exemplary methods for performing the functionality briefly described above of the quote engine 200. One of ordinary skill will recognize that the described methods are exemplary in nature and certain changes may be made without departing from the scope of the present invention.

The flowchart of FIG. 3 pertains to a method by which the web browser applications 222, 224 may be developed. In step 302, an administrator or other user of the quote engine 200 visits a carrier web site 208, 210. The purpose of the visit is to mimic the behavior of a consumer that would visit the carrier web site to receive a premium quote in order to determine what pages are presented and what information is requested by those pages. For example, the administrator may login to a carrier web site 208, 210, select from among a variety of insurance products, and traverse the series of web pages that ask for customer information needed to produce an insurance quote. Thus, in step 304, the administrator may log, or record, the interaction with the carrier web site 208, 210 in order to collect the desired information.

Advantageously, the information from the web pages associated with each insurance product offered by each carrier are stored separately. Thus, the information is accessible based on an insurance carrier ID and a product ID. The information from the web pages includes the questions associated with an input element (e.g., Have you had an accident in the last 5 years?) and also includes the type of input element (e.g., text box, radio button, pull-down menu selection, etc.). Other information from each web page include the options available to proceed to the next page in the sequence (e.g., “Click here when done”, “Continue”, “Return to previous page”, etc.).

Based on the questions encountered in the web pages, a set of questions is developed in step 308, for a particular insurance product. The above-mentioned steps 302 and 304 are repeated for each insurance carrier web site and each insurance product. Thus, for a automobile insurance policy, the questions from all the different carriers can be analyzed to determine a set of questions that will satisfy every insurance carrier's web site. For example, one carrier web site may ask “Have you had an accident in the last 5 years?” While some other carrier web site may ask if you had one in the last 3 years. Accordingly, a question that might be developed in step 308 would be “How long ago was your most recent accident?” The answer to this question can be used to answer the different questions from the different carrier web sites. Also, one carrier web site may ask the color of the car to be insured, while another carrier web site does not concern itself with vehicle color. In this instance, the “color” question will still be developed in step 308 because at least one carrier requires that information. Thus, in step 308, a set of questions is developed that will solicit enough information from a user in order to answer all the questions at any of the carrier web sites for a particular insurance product. When these questions are presented to a user, the received answers are stored to be used when interacting with the carrier web sites. Any number of alternative methods for storing data are contemplated herein. In general, though, the data is stored as a label and an associated value such that referencing the label will allow access to the associated value.

Also, based on the information collected from the carrier web site, a software application, or program, is developed, in step 306, that will complete the series of web pages from the carrier web site 208, 210. The program is developed to perform the actions that mimic a user's interaction with the carrier web site. In operation, the software application acts similar to a web browser in that it first establishes a connection with the carrier web site. The address of the web site may be included in the program itself when it is developed, or it may be dynamically passed this address upon its invocation by the data controller 218. The connection may be established to the general home page of a carrier web site 208, 210 or it may be established to an insurance product specific page (e.g., home-owners insurance) within the carrier web site. Regardless of where it starts, the program is structured to traverse the presented web pages as they are encountered.

Once the connection is established, the software application executes so as to mimic the behavior of a user performing input events at a web browser. By this, it is meant that the software application, or program, mimics the entering of keystrokes, mouse events and other inputs events that a user might perform while encountering the web pages of the carrier web site. The actual data values that are being used when mimicking user input is the data stored about a user when that user answered the questions developed in step 308. Thus if a web page requests the user's first and last name, this information can be retrieved from the database and used to interactively produce input that is sent back to the carrier web site presenting that particular web page. The software application may have more intelligence than simply transcribing information from the database to the web page. For example, the user data may indicate that the user's last accident was 48 months ago. However, the precise question of the web page may be a yes or no question or a radio selection button that asks “Have you had an accident in the last 5 years?” Thus, the software application may perform intelligent actions exemplified by the following pseudo-code, such as:

If (recent.accident>=60) then answer=“No”) else
Answer=“Yes”;

output Answer.

The output of the “Answer” may be a string of characters or the selection of an available radio button or some other alternative. Thus, any of a variety of outputs can be provided by the software application when mimicking the behavior of a user.

One of ordinary skill will appreciate that the providing of output from the software application may be accomplished in a variety of different ways without departing from the scope of the present invention. For example, one well known method of providing data from a web browser to a web server is using forms with the POST command. According to this method, the “variable name” and “value” are matched pairs that are combined into a sequence separated by “+” symbol and sent back to the web server. In other instances, a dynamic web component in a web browser may interactively receive input via the web browser and dynamically return it to the web server much like a remote terminal that echoes keystrokes as they occur. Thus, these and other similar methods for mimicking the input provided by a user of the carrier web sites are all considered within the scope of the present invention.

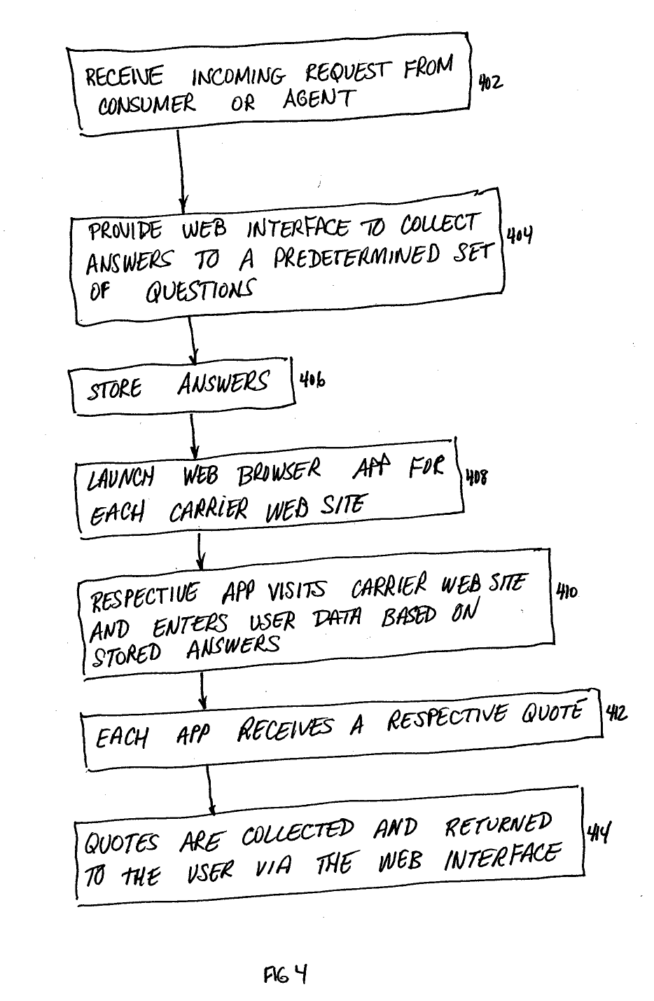

FIG. 4 depicts an exemplary flowchart of a method for receiving an insurance quote from multiple carrier web sites. In step 402, the quote engine 200 receives an incoming request from a user 202, 204 using a web browser to access a web server portion of the quote engine. The quote engine determines what type of insurance product the user is desiring so as to determine which questions to ask the user.

In step 404, the quote engine 200 retrieves, from a data store, the questions that relate to the particular insurance product of interest and presents these questions to the user. In return, the user provides answers to these questions and the answers are stored, in step 406. Once the answers are received from the user, the carrier web sites may be accessed. To perform this connection, the quote engine determines which web browser applications exist for that particular insurance product, each web browser application being associated with a different carrier web site. Thus, in step 408, the quote engine launches each of these web browser applications.

Each web browser application connects to its respective carrier web site and begins interacting with that web site, in step 410. The web browser application behaves just as if a user was interfacing with the web site and provides data to the web site based on the information stored in the quote engine. Once the web browser application completes the last input screen at the carrier web site, the carrier web site can calculate and provide an insurance premium quote. It is worth noting that the web browser application interfaces with the carrier web sites and its data is not necessarily displayed on the user web interfaces 212, 214.

In step 412, each carrier web site provides a respective premium quote that is received by the quote engine through the respective web browser application. In step 414, the data controller 418, collects the different quotes and provides them to a user 202, 204 through their respective interface 212, 214. As a result, the user 202, 204 is provided with multiple insurance quotes while having to input answers to relevant questions only once. This is possible because the quote engine visits each of a plurality of carrier web sites and programmatically provides input to a series of questions in one or more web pages just as if a user was providing the same input.

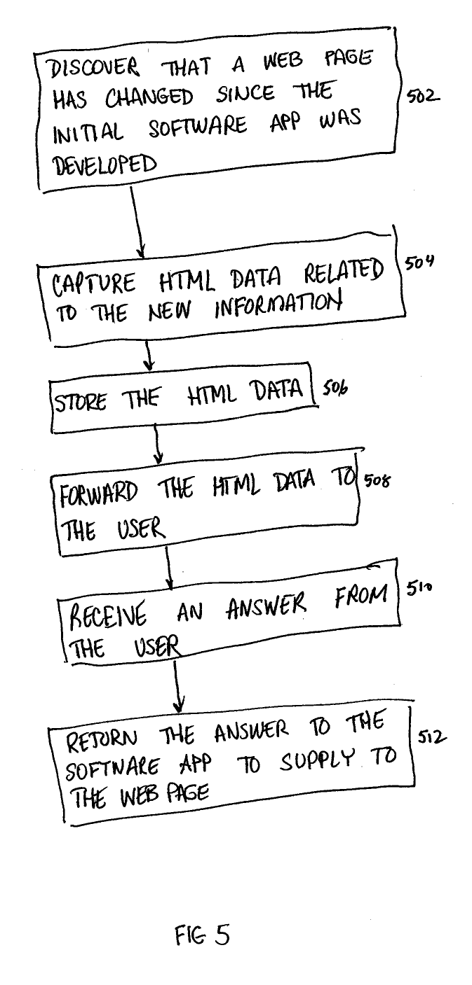

As mentioned earlier, the quote engine 200 may include a maintenance component 226 because carrier web sites may change. FIG. 5 depicts a flowchart of an exemplary method for detecting and handling changes that may occur to carrier web sites 208, 210.

In step 502, the web browser application 222, 224 may discover that the carrier web site 208, 210 provided unexpected information. This discovery may occur in a variety of different ways without departing from the scope of the present invention. As one example, the carrier web site may add an additional question to a particular web page. Thus, when the web browser application 222, 224 fills in the data according to its programmatic instructions and submits the input, the carrier web site 208, 210 may provide an error page identifying the question that was not answered. Alternatively, the carrier web site 208, 210 may redisplay the current page with the missing information highlighted or otherwise denoted. In another, more proactive alternative, the web browser application may compare a recently retrieved web page to the original web page stored in the quote engine to determine if any differences exist before filling in the data.

In any of the above alternatives, the common factor is that the carrier web site 208, 210 includes additional, unexpected HTML data in a web page that describes a request for information that the web browser application 222, 224 cannot fulfill. Thus, in step 504, the web browser application 222, 224 captures this additional HTML data and stores it, in step 506. In particular, the HTML data includes such information as a data element name or label and an associated data element type (e.g., text box, radio button, drop menu, etc.) This captured information may be easily converted into XML formatted data and stored as such. Converting and storing the captured data in XML format simplifies the reading and writing of such data using industry-standard tools, allows data validation, permits capturing of images, scripts, applets and other complex elements, and allows the XML data to be presented to a user with a look-and-feel that is not dependent on the original carrier's HTML code

Advantageously, this data, regardless of its specific format, is stored in such a way that it is accessible by a carrier ID, product ID and possibly a page (or other location) ID. This identification of the data allows it to be retrieved if that page is encountered by another subsequent user of the quote engine. For example, returning to step 410 of FIG. 4, the web browser application when encountering a page on a carrier web site may search to see if there is any record of that page being updated by the maintenance component 226. One way to determine if such a record exists is to search to see if any additional HTML data has been identified for that carrier, product and web page. If so, then the web browser application can anticipate that additional information will be needed and query the user 202, 204. Thus, the web browser application can fill in all the data without generating an error.

In step 508, the captured data, advantageously in XML format, is used to populate a web page that is sent to the user 202, 204. One example of such a page is an ASPX page that is dynamically populated using XSLT to translate the XML, as is well-known in the art. While such a technique provides many of the benefits identified above such as simplifying reading, writing, and validating of data, the web pages provided to the user may employ a variety of other technologies such as ASP, JSP, PHP, HTML, etc. This page is received by the user and may indicate for example “To continue processing your request would you please input the color of the car to be insured?”

The user 202, 204 replies to this page with “Green”, or some appropriate input, in step 510. Once the reply is received, control returns to the web browser application, in step 512, which continues supplying data (including the additional data) to a carrier web site 208, 210. Thus, the maintenance component recognizes when the web browser application encounters a request for input that cannot be handled and initiates contact with the user to supply the additional information which, in turn, is ultimately supplied to the carrier web sites. The maintenance component may also create a log of changed web pages that can be sent to a program developer who can respond by updating the web browser applications in view of the changes at the carrier web sites.

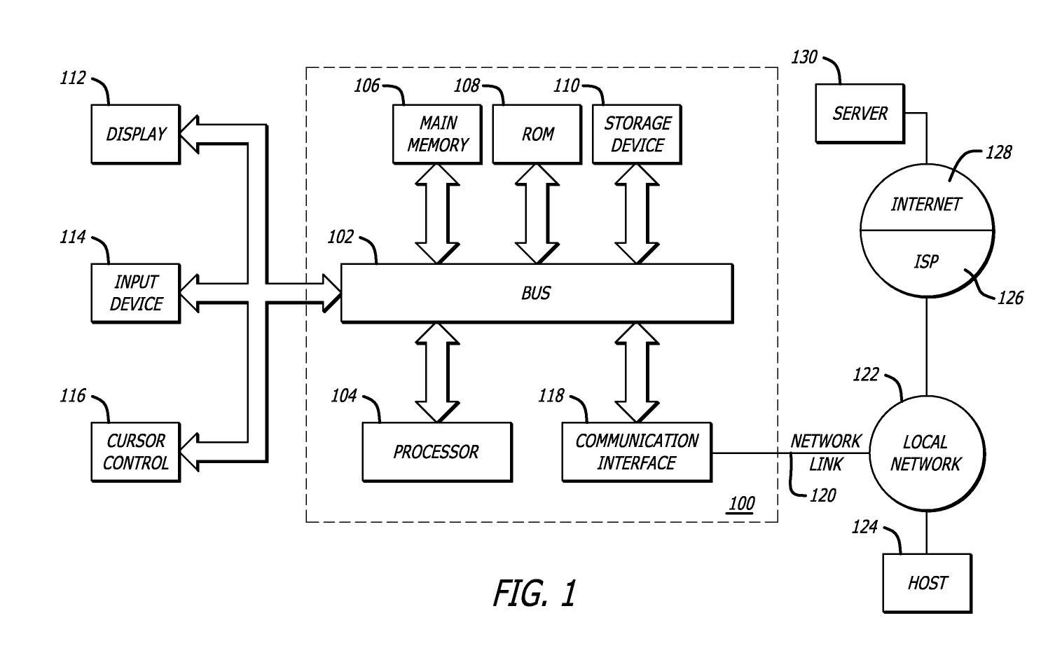

At least portions of the invention are intended to be implemented on or over a network such as the Internet. An example of such a network is described in FIG. 1, attached. FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A communications system comprising:
a first interface configured to communicate with a user to receive first data and to provide resulting data;
a second interface configured to communicate with a plurality of web pages that each requests respective second data, and to receive respective output data;
a plurality of executable software applications, each software application associated with one of the plurality of web pages and configured to provide the respective second data based on the first data and in a format based on the associated web page and receive the respective output data; and
a controller, in communication with the first and second interfaces, configured to receive a request via the first interface and, in response, execute one or more of the executable software applications, and collect the respective output data to generate the resulting data.
